(19) United States
(12) Patent Application Publication
(10) Pub. No.: US 2009/0164744 A1
(43) Pub. Date: Jun. 25, 2009

(54) Memory access protection

(75) Inventor: Robert Norman, Pendleton, OR (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, SUNNYVALE, CA (US)

(21) Appl. No.: 12/004,734

(22) Filed: Dec. 24, 2007

(51) Int. Cl. G06F 12/14

(52) U.S. Cl. 711/164; 711/E12.093

(57) ABSTRACT

A memory system is provided. The memory system includes a memory array and a memory controller in communication with the memory array. The memory controller is configured to receive a first password and to compare the first password with a second password. The second password is stored in the memory controller. If the first password matches the second password, then access is permitted to the memory array. The memory array can include a plurality of vertically stacked memory arrays. The vertically stacked memory arrays can be formed on top of a logic plane that includes active circuitry in communication with the vertically stacked memory arrays. The memory arrays can include two-terminal memory cells that store data as a plurality of conductivity profiles and retain the stored data in the absence of power. The memory arrays may be configured as non-volatile two-terminal cross-point memory arrays.

### FIELD OF THE INVENTION

The present invention relates to semiconductors and, more particularly, to memory access protection.

### BACKGROUND

Electronic systems typically incorporate many types of memory technologies. For example, an electronic system may include both static random access memory (SRAM) and dynamic random access memory (DRAM). Electronic system can use the SRAM for small buffer memory and for high speed cache for processors. DRAM can be used for temporary storage of code and/or of large amounts of data used by applications.

It should be appreciated that a memory can be partitioned into multiple portions. In other words, a memory can be separated into multiple areas. The memory is partitioned such that each partition can be used for a different purpose or application. Typically, memory management and partition is handled by software executed on the electronic system. For instance, an operating system is usually programmed to handle the operations associated with memory management and partition. In electronic systems that use multiple memory technologies and run multiple applications, memory management can be a large task that can be processor intensive. An error in the software that handles memory management and partitioning can result in data corruption and/or electronic system crash.

Furthermore, as electronic systems become smaller, fewer types of memory technologies are used. As a result, the type of memory used by small electronic systems can be large and dense. The complexity of managing memories increases with the size and density of the memories. Similarly, the risks of data corruption and/or electronic systems crash also increase. As a result, there is a need for continuing efforts to improve access protection in memory systems.

### BRIEF DESCRIPTION OF THE DRAWINGS

The present invention will be readily understood by the following detailed description in conjunction with the accompanying drawings, and like reference numerals designate like structural elements. Although the Drawings depict various examples of the invention, the invention is not limited by the depicted examples. Furthermore, the depictions are not necessarily to scale.

FIG. 1 is a simplified block diagram of a memory system, in accordance with an embodiment;

FIG. 2 is a simplified block diagram of a third dimension memory array, in accordance with an embodiment;

FIG. 3 is a flowchart diagram of a general overview for memory access protection, in accordance with an embodiment;

FIG. 4 is a schematic diagram of a password protection circuitry, in accordance with an embodiment;

FIG. 5 is a simplified block diagram of a memory array divided into multiple portions, in accordance with an embodiment;

FIG. 6 is a schematic diagram of a password protection circuitry configured to access one or more portions of a memory array, in accordance with an embodiment; and

FIG. 7 is a schematic diagram of circuitry for outputting a value with an invalid password, in accordance with an embodiment.

### DETAILED DESCRIPTION

A detailed description of one or more embodiments is provided below along with accompanying figures. The detailed description is provided in connection with such embodiments, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

The embodiments described herein provide memory systems for memory access protection. In one embodiment, the memory system receives a password in an access operation to access a memory array. Access is granted if the password matches an access or master password stored in the memory system. Otherwise, if the password does not match the access or master password, then access to the memory array is denied. As explained in more detail below, access protection of the memory system can protect the entire memory array or portions of the memory array.

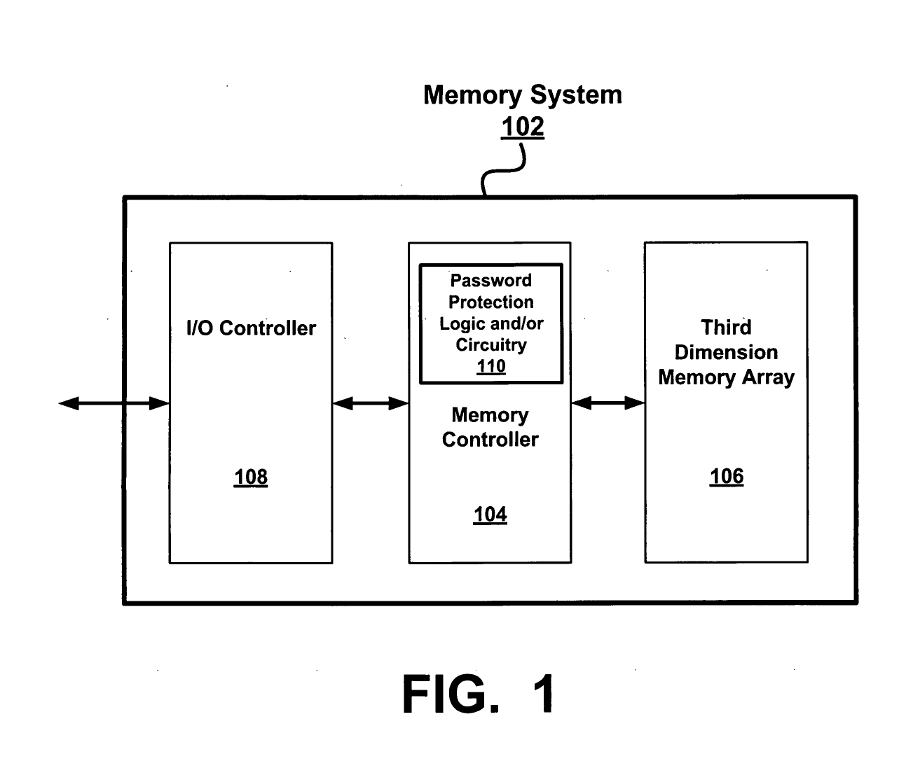

FIG. 1 is a simplified block diagram of a memory system 102, in accordance with an embodiment. As shown in FIG. 1, memory system 102 may include input/output (I/O) controller 108, memory controller 104, and third dimension memory array 106. Memory controller 104 is connected to or in communication with I/O controller 108 and third dimension memory array 106. In general, I/O controller 108 may be configured to control the transfer of data, memory addresses, and instructions. For example, the transfer may be bi-directional where data are outputted from I/O controller 108 during read operations and, at other times, the data are inputted into the I/O controller 108. Third dimension memory array 106, as explained in more detail below, is configured to store data based on the resistive state of the memory elements. Memory controller 104 includes logic to control and to manage the flow of data to and from third dimension memory array 106 (e.g., data operations such as read and write access). For example, memory controller 104 may include logic to read and write data to third dimension memory array 106. In an embodiment, memory controller 104 can additionally include password protection logic and/or circuitry 110. As explained in more detail below, password protection logic and/or circuitry 110 includes logic and/or circuitry to control the access of data stored in third dimension memory array 106 based on passwords.

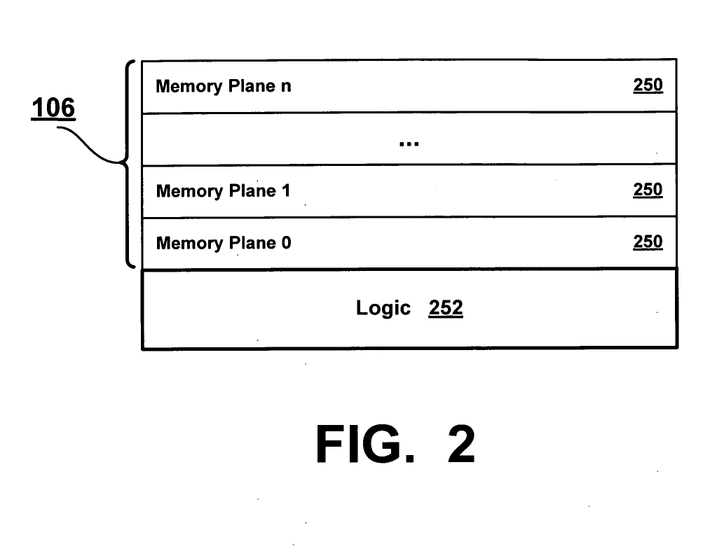

FIG. 2 is a simplified block diagram of a third dimension memory array 106, in accordance with an embodiment. Third dimension memory array 106, which is connected to logic 252 and may be disposed above the logic 252 (e.g., may be positioned on top of logic 252), can include a memory array that is vertically configured along multiple memory planes 250. It should be appreciated that logic 252 may include a variety of logic and/or circuitry that is associated with a memory system. For example, logic 252 may include a memory controller and an I/O controller. The memory controller may include direct memory access (DMA) functionality. Additionally, for example, logic 252 may also include password protection logic and/or circuitry. Memory planes 250 can be implemented to emulate various types of memory technologies that permit different physical and logical arrangements (e.g., vertically stacked memory arrays). A memory is “third dimension memory” when the memory is fabricated above other circuitry components, the components usually including a silicon substrate, polysilicon layers and, typically, metallization layers. By using non-volatile third dimension memory arrays, such as third dimension memory array 106, memory systems may be vertically-configured to reduce die size and not sacrifice overall chip functionality.

Third dimension memory array 106 can be a two-terminal cross point array where, as shown in the embodiment of FIG. 2, memory arrays in the form of memory planes 250 may be stacked on top of logic 252. U.S. patent application Ser. No. 11/095,026, filed Mar. 30, 2005, and titled “Memory Using Mixed Valence Conductive Oxides,” hereby incorporated by reference in its entirety and for all purposes, describes non-volatile third dimension memory elements (i.e., memory cells) that can be arranged in a cross point array. The application describes a two-terminal memory element that changes conductivity when exposed to an appropriate voltage drop across the two terminals. Multiple layers of the cross-point arrays may be vertically stacked upon one another to form the aforementioned vertically stacked array configuration. The memory element includes an electrolytic tunnel barrier and a mixed valence conductive oxide. The voltage drop across the electrolytic tunnel barrier causes an electrical field within the mixed valence conductive oxide that is strong enough to move oxygen ions out of the mixed valence conductive oxides and into the electrolytic tunnel barrier. Oxygen depletion causes the mixed valence conductive oxide to change its valence, which causes a change in conductivity. Both the electrolytic tunnel barrier and the mixed valence conductive oxide do not need to operate in a silicon substrate, and, therefore, can be fabricated above circuitry being used for other purposes (e.g., such as selection circuitry). The memory element stores data as a plurality of conductivity profiles that can be non-destructively determined by applying a read voltage across the terminals of the memory element. The memory element retains stored data in the absence of power. The two-terminal memory elements can be arranged in a cross point array such that one terminal is electrically coupled with an x-direction line and the other terminal is electrically coupled with a y-direction line.

Both the electrolytic tunnel barrier and the mixed valence conductive oxide do not need to operate in a silicon substrate and, therefore, can be fabricated above circuitry being used for other purposes (such as logic 252). The two-terminal memory elements can be arranged in a cross point array such that one terminal is electrically coupled with an x-direction line and the other terminal is electrically coupled with a y-direction line. A stacked cross point array consists of multiple cross point arrays vertically stacked upon one another, sometimes sharing x-direction and y-direction lines between layers, and sometimes having isolated lines. When a first write voltage V_{W1} is applied across the memory element, (typically by applying ½ V_{W1} to the x-direction line and ½ −V_{W1} to the y-direction line) it switches to a low resistive state. When a second write voltage V_{W2} is applied across the memory element, (typically by applying ½ V_{W2} to the x-direction line and ½ −V_{W2} to the y-direction line) it switches to a high resistive state. Typically, memory elements using electrolytic tunnel barriers and mixed valence conductive oxides require V_{W1} to be opposite in polarity from V_{W2}.

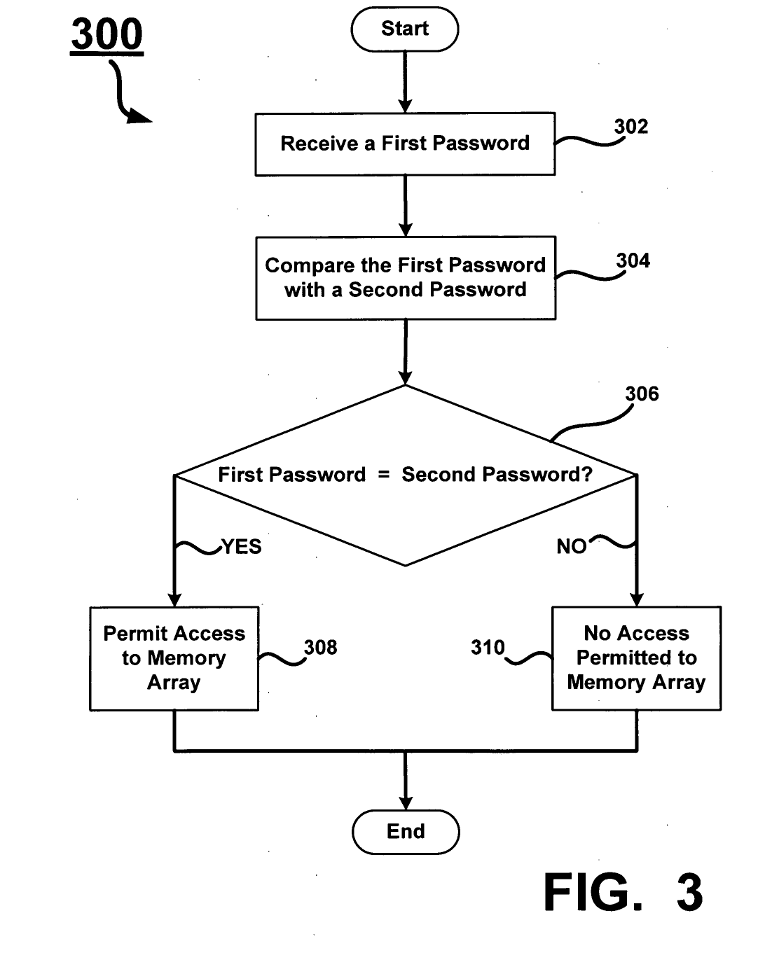

FIG. 3 is a flowchart diagram 300 of a general overview for memory access protection, in accordance with an embodiment. At a stage 302, a first password is received. The first password may be assigned a memory address. For example, the first password may be assigned to four memory addresses. In another example, the first password may be assigned to eight memory addresses. Thereafter, at a stage 304, the first password is compared with a second password stored in the memory controller, the memory array, one or more registers, or at another location within the memory system. This second password may or may not be associated with the memory address. If the first password matches the second password, then access is permitted to the memory array or a portion of the memory array at a stage 308. If the first password does not match the second password, then access is not permitted to the memory array or a portion of the memory array at a stage 310. It should be noted that access operations may include writing (or programming) data, reading data, erasing data, verifying data, and other access operations.

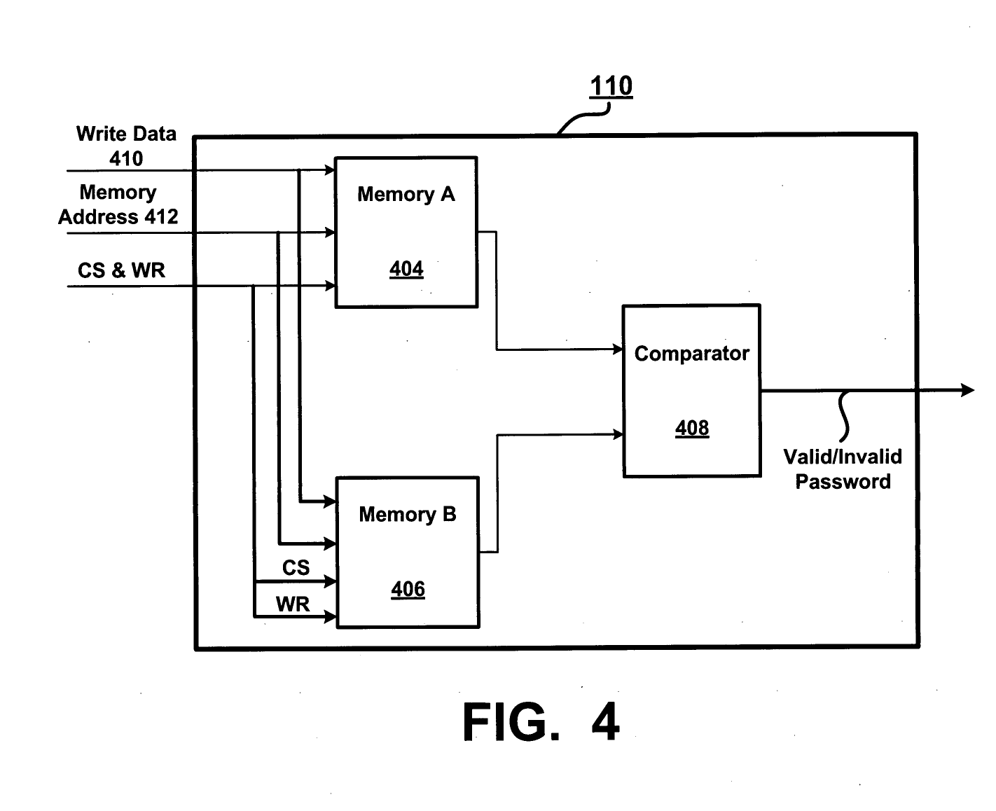

FIG. 4 is a schematic diagram of a password protection circuitry 110, in accordance with an embodiment. Password protection circuitry 110 includes comparator 408 in communication with Memory A 404 and Memory B 406. Memory A 404 and Memory B 406 can include a variety of different memories, such as a third dimension memory array, a register, or a non-volatile memory (NAND, NOR, Divided bit-line NOR (DINOR), AND, and other non-volatile memories). Comparator 408 may, for example, be XOR or XNOR digital compare gates. Comparator 408 comprises two or more inputs and an output. Comparator 408 includes an array of compare elements combined in a logic tree to give a compare or not compare value based on the two input values. The first input of comparator 408 is coupled to and in communication with Memory A 404. The second input of comparator 408 is coupled to and in communication with Memory B 406.

As shown in FIG. 4, in a write operation, Memory A 404 receives write data 410 and memory address 412 associated with the write data. It should be noted that in a read operation, Memory A 404 receives memory address 412 but not write data 410. In this embodiment, a first password is assigned to memory address 412. However, in another embodiment, Memory A 404 can receive the first password separately from memory address 412. In other words, the first password may be independent of the memory address. Memory B 406 is configured to store a second password. With the receipt of the first password, comparator 408 retrieves the first password and the second password from Memory A 404 and Memory B 406, respectively. Thereafter, comparator 408 compares the first password with the second password. If the first password and the second password match, then comparator 408 outputs a value (e.g., 0 or 1) that signals a valid password, which permits access to the memory array. On the other hand, if the first password and the second password do not match, then comparator 408 outputs a value (e.g., 0 or 1) that signals an invalid password, which prohibits access to the memory array.

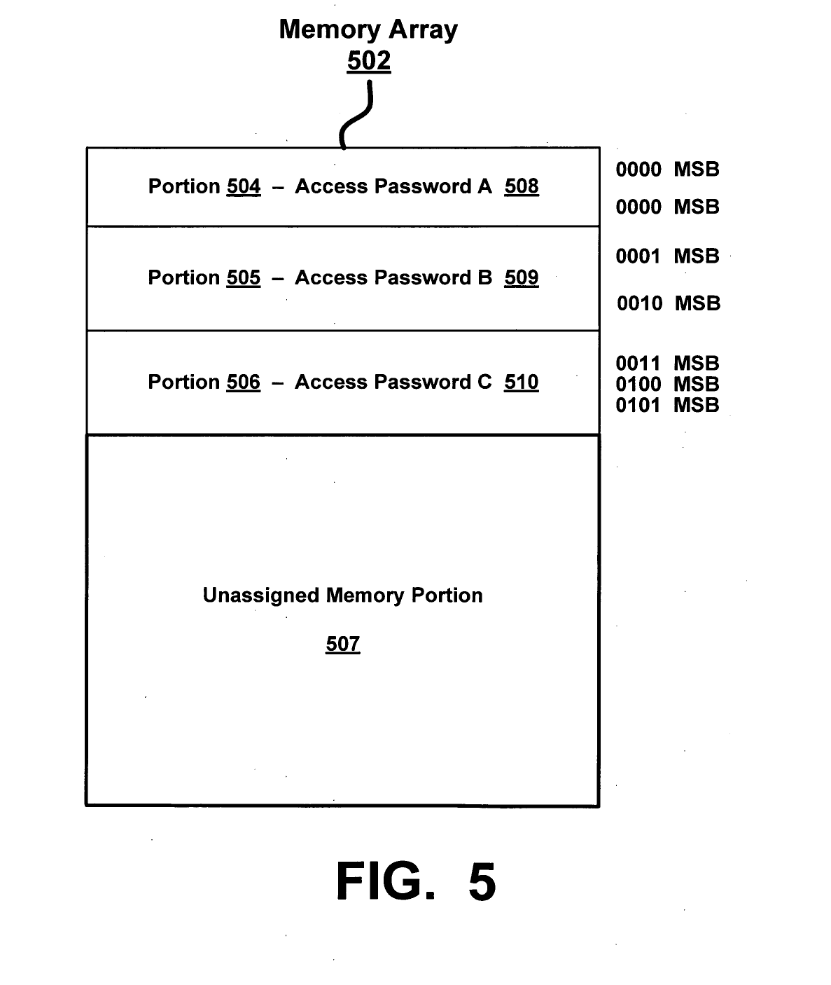

FIG. 5 is a simplified block diagram of a memory array 502 divided into multiple portions, in accordance with an embodiment. It should be appreciated that the memory array 502 can be divided into multiple portions, such as portions 504-507. Portions 504-507 may include, for example, memory planes, memory blocks, pages, sectors, and other portions. For instance, portions 504-507 may be memory planes. Memory planes can be further divided into memory blocks. As a result, for example, portions 504-507 may be memory blocks associated with one memory plane. A memory block can be further divided into pages of memory cells. Accordingly, portions 504-507 may be pages of memory cells within a memory block. The pages may be further divided into sectors. Thus, in another example, portions 504-507 may be sectors within a page.

A password, such as access password 508, 509, or 510, can be associated with or assigned to each portion 504, 505, or 506. As shown in FIG. 5, access password A 508 is associated with portion 504, access password B 509 is associated with portion 505, and access password C 510 is associated with portion 506. A match of the received password with access password 508, 509, or 510 permits access to the associated portion 504, 505, or 506. In other words, a match of a password with access password A 508 permits access to portion 504. A match of the password with access password B 509 permits access to portion 505. A match of the password with access password C 510 permits access to portion 506.

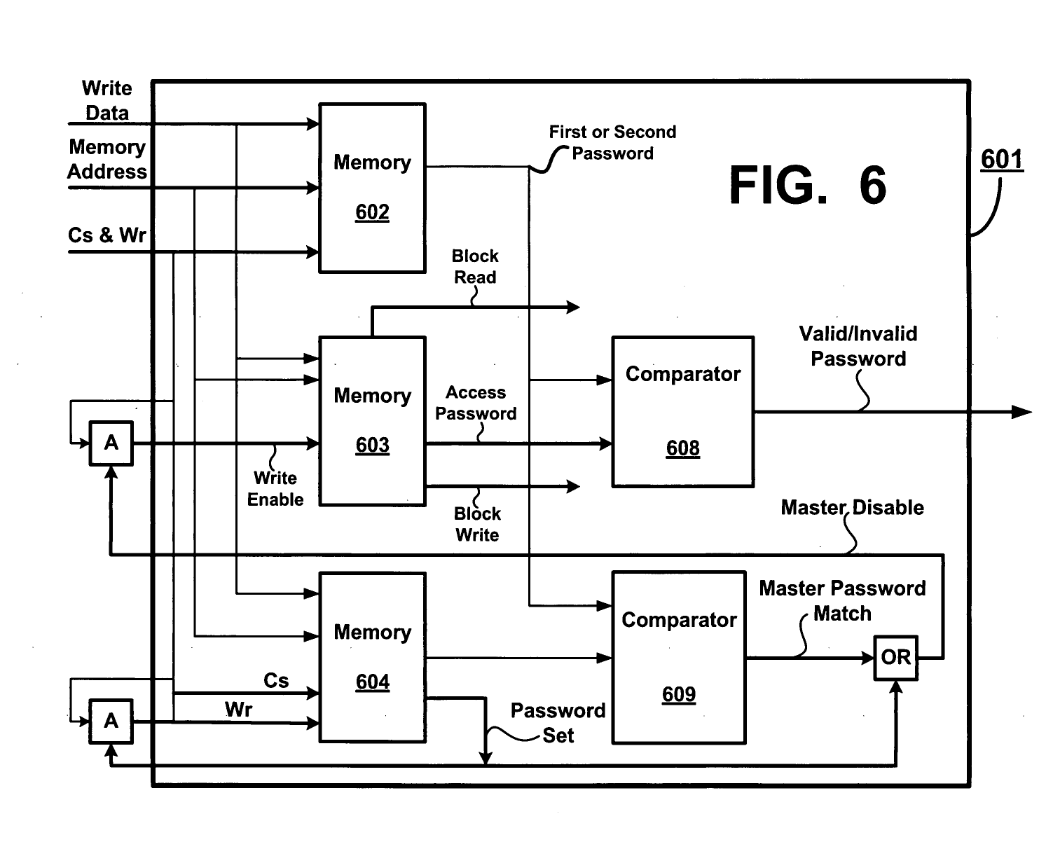

FIG. 6 is a schematic diagram of a password protection circuitry 601 configured to access one or more portions of a memory array, in accordance with an embodiment. Password protection circuitry 601 includes memories 602-604 and comparators 608-609. Comparator 608 is coupled to and in communication with memories 602 and 603. Comparator 608 comprises multiple inputs and an output. One input of comparator 608 is in communication with memory 602. The other input of comparator 608 is in communication with memory 603. The output of comparator 608 is in communication with a memory array (not shown). Password protection circuitry 601 also includes comparator 609 that is coupled to and in communication with memories 602-604. In the embodiment of FIG. 6, comparator 609 comprises multiple inputs and an output. One input of comparator 609 is in communication with memory 602. The other input of comparator 609 is in communication with memory 604. The output of comparator 609 is in communication with memory 603.

Initially, memory 602 is configured to receive a first password (i.e., a first temporary password). In an embodiment, the first password may be assigned to a memory address. Memory 602 receives the first password and temporarily stores the first password in memory 602. Memory 604 is configured to store a master password, which has been previously set and stored in memory 604. Comparator 609 is configured to receive both first password and master password from memory 602 and 604, respectively, and to compare the first password with the master password. If the first password matches the master password, then comparator 609 outputs an enable signal to memory 603. If the first password does not match the master password, then comparator 609 outputs a disable signal to memory 603. The enable signal enables memory 603 to receive the memory access control. The disable signal blocks memory 603 from receiving the memory access control. As such, a match of the first password and the master password allows access to memory 603, and therefore, as explained in more detail below, further allows access to portions of the memory array.

It should be noted that the master password protection can be used to setup or enable other password protection schemes, as will be explained in more detail below. In an embodiment, if the master password is not programmed or stored in memory 604, the memory system can allow access to the memory array. However, once the master password is programmed in memory 604, the memory system may conduct a password check, as described above, for each access operation.

Memory 603 may be configured to store passwords (“access passwords” or “look-up passwords”) associated with different memory addresses. Here, one or more memory addresses may be associated with an access password. Data located at a memory address may be accessed if a received password matches the access password associated with the memory address. The access passwords and associated memory addresses may be stored in a variety of data structures. Examples of data structures include tables, arrays, and other data structures. The following Table A is an example of a table that stores both memory addresses and associated access passwords.

TABLE A

| Memory Addresses (Four Most | |
|---|---|
| Significant Bits) | Passwords |
| 0000 | Password A |
| 0001 | Password B |
| 0010 | Password B |
| 0011 | Password C |
| 0100 | Password C |
| 0101 | Password C |

Still referring to FIG. 6, in a subsequent access operation, memory 602 is cleared of the first password and may then be further configured to receive a second password (i.e., second temporary password). In an embodiment, the second password may be assigned to a second memory address associated with the access operation. The second password loaded in memory 602 is compared to the values (i.e., access passwords) for each access of memory array. Once the second password is loaded in memory 602, memory 603 loads or receives the memory address that is associated with the second password (e.g., the most significant bits of the memory address). As a result, memory 603 stores the second password for the portion of the memory array being requested.

For example, with reference to Table A, if memory 603 receives a 0101 memory address, then associated Password C is retrieved from memory 603 based on the 0101 memory address and Password C is outputted to comparator 608. In another example, with reference to Table A, if memory 603 receives a 0000 memory address, then associated Password A is retrieved from memory 603 based on the 0000 memory address and Password A is outputted to comparator 608. After the access password associated with the memory address has been retrieved, comparator 608 receives the second password (or presently loaded password) from memory 602 and the access password from memory 603. Thereafter, comparator 608 compares the second password with the access password. If the second password matches the access password, then comparator 608 outputs a signal indicating a match and therefore allows the access operation to proceed. On the other hand, if the second password does not match the access password, then comparator 608 outputs a signal indicating a mismatch and therefore blocks the access operation from proceeding.

Reference can be made again to FIG. 5 for an example of an access operation. As discussed above, FIG. 5 is a simplified block diagram of a memory array divided into multiple portions, in accordance with an embodiment. In this illustrative example, portions 504-506 are set for different applications or different file usages. Here, memory array 502 is divided into sixteen equal areas. As such, the four most significant bits define the partition boundaries. Portion 504 can be referenced by a 0000 memory address. Portion 505 can be referenced by 0001 and 0010 memory addresses. Portion 506 can be referenced by 0011, 0100, and 0101 memory addresses. As discussed above, passwords can be assigned to each portion 504, 505, or 506. As a result, for example, a user may program a password to be associated with each portion 504, 505, or 506. The aforementioned Table A lists examples of passwords that may be associated with each portion 504-506.

To access a portion 504, 505, or 506, a password that matches the access password associated with the portion is loaded into the password protection circuitry. For example, to access portion 505, access password B 509 is loaded into the password protection circuitry. With a match, for example, data can be written to or read from portions with 0001 and 0010 memory addresses. If an attempt is made to access portion 506 with access password B 509, then password protection circuitry will output an invalid compare and thereby block or prohibit the access of portion 506.

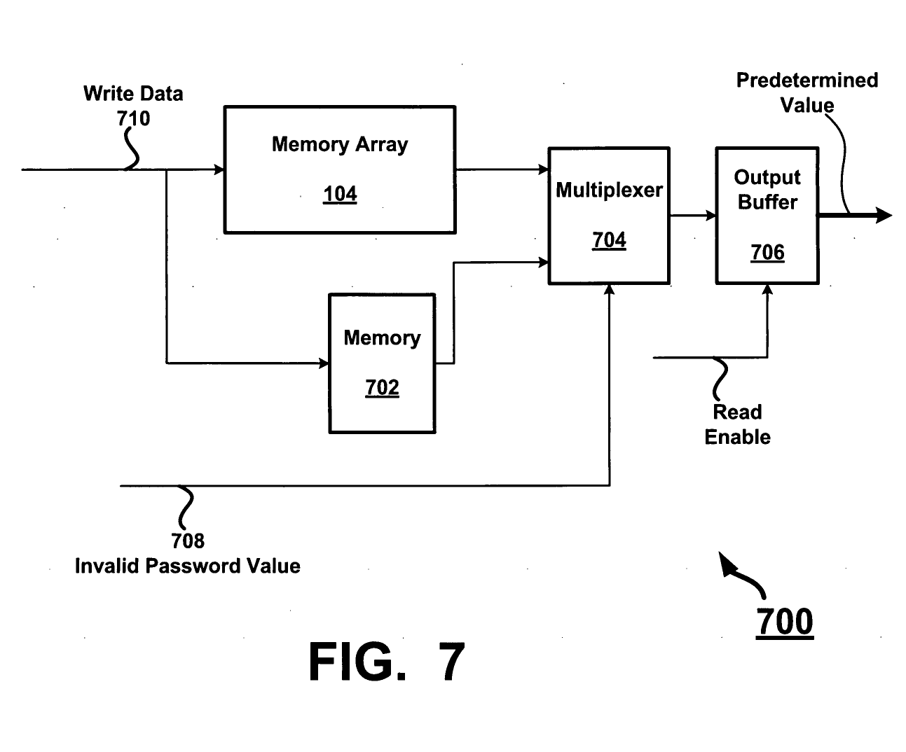

FIG. 7 is a schematic diagram of circuitry 700 for outputting a value with an invalid password, in accordance with an embodiment. It should be noted that the password protection circuitry shown in FIG. 6 may output a value associated with an invalid password. Such value may be random and indistinguishable from a value outputted as a result of a valid password. Accordingly, an embodiment may include a circuitry added to the password protection circuitry to convert the value associated with an invalid password to a particular value. As shown in FIG. 7, such circuitry 700 may include memory 702 (e.g., a register), multiplexer 704, and output buffer 706. Multiplexer 704 is coupled to and in communication with memory array 104 and memory 702. Additionally, output buffer 706 is coupled to and in communication with multiplexer 704.

Memory 702 is configured to store a value associated with an invalid password. For example, such value can include zeros “0000” or other, predetermined values. Multiplexer 704 is configured to receive data from memory array 104 and the value associated with an invalid password from memory 702. Thereafter, multiplexer 704 outputs either the data from memory array 104 or value associated with an invalid password from memory 702. Multiplexer 704 selects the data or value for output based on value 708 associated with an invalid password that is outputted from the password protection circuitry. For example, if value 708 outputted from password protection circuitry is associated with an invalid password, then multiplexer 704 receives value 708 and, based on value 708, selects a value (e.g., “0000”) received from memory 702 for output. On the other hand, if value 708 outputted from password protection circuitry is associated with a valid password, then multiplexer 704 outputs the data received from memory array 104. The output of multiplexer 704 is then transmitted to output buffer 706. As a result, the circuitry of FIG. 7 can force or convert an invalid password value received from the password protection circuitry to a predetermined value that can be distinguished from a value associated with a valid password.

Although the foregoing embodiments have been described in some detail for purposes of clarity of understanding, the embodiments are not limited to the details provided. There are many alternative ways of implementing the embodiments. Accordingly, the disclosed embodiments are to be considered as illustrative and not restrictive, and the embodiments are not to be limited to the details given herein, but may be modified within the scope and equivalents of the appended claims. In the claims, elements and/or operations do not imply any particular order of operation, unless explicitly stated in the claims.

What is claimed is:

1. A memory system, comprising:
a memory array; and
a memory controller in communication with the memory array, the memory controller being configured to
receive a first password,
compare the first password with a second password, the second password being stored in the memory controller, and
permit access to the memory array if the first password matches the second password.

2. The memory system of claim 1, wherein the access is permitted to only a portion of the memory array.

3. The memory system of claim 1, wherein the memory controller is further configured to:
receive a memory address; and
retrieve the second password based on the memory address.

4. The memory system of claim 1, wherein the memory array comprises a third dimension memory array.

5. A memory system, comprising:
a memory array;
a first memory configured to receive a first memory address, the first memory address including a master password;
a second memory configured to store a first temporary password; and
a first comparator in communication with the memory array, the first memory, and the second memory, the first comparator being configured to compare the master password with the first temporary password.

6. The memory system of claim 5, wherein a match of the master password and the first temporary password permits access to the memory array.

7. The memory system of claim 5, wherein the first temporary password is associated with the first memory address.

8. The memory system of claim 5, wherein the first memory is configured to receive a second temporary password, the memory system further comprising:
a third memory in communication with the first comparator, the third memory being configured to store an access password, the access password being associated with a portion of the memory array; and
a second comparator in communication with the first memory, the third memory, and the memory array, the second comparator being configured to compare the second temporary password with the access password.

9. The memory system of claim 8, wherein the portion of the memory array is a memory block.

10. The memory system of claim 8, wherein a match of the second temporary password and the access password permits access to the portion of the memory array.

11. The memory system of claim 5, wherein the memory array comprises a third dimension memory array.

12. A memory system, comprising:
a third dimension memory array;
a first memory configured to receive a first memory address, the first memory address including a first password;
a second memory configured to store a second password associated with the first memory address; and
a first comparator including a first input, a second input, and an output, the first input being in communication with the first memory, the second input being in communication with the second memory, the output being in communication with the third dimension memory array, the first comparator being configured to compare the first password with the second password.

13. The memory system of claim 12, wherein the first memory and the second memory are registers.

14. The memory system of claim 12, wherein the third dimension memory array includes a plurality of non-volatile two-terminal cross-point memory arrays that are vertically stacked upon each other.

15. A memory system, comprising:
a third dimension memory array;
a first memory configured to receive a first memory address, the first memory address including a first password;
a second memory configured to store a second password, the second password being associated with the first memory address;
a third memory configured to store a third password;
a first comparator in communication with the third dimension memory array, the first memory, and the second memory, the first comparator being configured to compare the first password with the second password; and
a second comparator in communication with the first memory and the third memory.

16. The memory system of claim 15, wherein the first memory is further configured to receive a second memory address, the second memory address including a fourth password, and wherein the second comparator is configured to compare the fourth password with the third password.

17. The memory system of claim 15, wherein the first comparator includes a first input, a second input, and an output, the first input being in communication with the first memory, the second input being in communication with the second memory, the output being in communication with the third dimension memory array.

18. The memory system of claim 15, wherein the second comparator includes a first input, a second input, and an output, the first input being in communication with the first memory, the second input being in communication with the third memory, the output being in communication with the second memory.

19. The memory system of claim 15, wherein the second comparator is configured to output an enable signal to the second memory, the enable signal enabling the first comparator to compare the first password with the second password.

20. The memory system of claim 15, wherein the third dimension memory array includes a plurality of non-volatile two-terminal cross-point memory arrays that are vertically stacked upon each other.
